(19) United States
(12) Patent Application Publication
(10) Pub. No.: US 2025/0312810 A1
(43) Pub. Date: Oct. 9, 2025

(54) COATING APPARATUS

(71) Applicant: TOYOTA JIDOSHA KABUSHIKI KAISHA, Toyota-shi (JP)

(72) Inventors: Takayasu SATAKE, Toyota-shi (JP); Yuichi TAKEYAMA, Toyota-shi (JP); Yusuke ONO, Toyota-shi (JP)

(73) Assignee: TOYOTA JIDOSHA KABUSHIKI KAISHA, Toyota-shi (JP)

(21) Appl. No.: 19/018,217

(22) Filed: Jan. 13, 2025

(30) Foreign Application Priority Data
Apr. 9, 2024 (JP) 2024-062543

(51) Int. Cl. B05C 5/02; B05C 11/10

(52) U.S. Cl. CPC B05C 5/0254; B05C 11/1013

(57) ABSTRACT

The coating apparatus includes a coating unit having a tank containing a coating material, a die head for discharging the coating material, a supply passage constituting a channel from the tank to the die head, a volume changing device for imparting a volume change to the supply passage, and a pressure sensor for detecting a pressure in an internal space of the die head, and a control unit for controlling an operation of the coating unit. The control unit is configured to determine whether or not the coating material can be ejected from the die head based on a change in pressure when a volume change is applied to the supply passage by the volume changing device, and start ejecting the coating material to the object to be coated when the ejection is possible.

### CROSS-REFERENCE TO RELATED APPLICATION

This application claims priority to Japanese Patent Application No. 2024-062543 filed on Apr. 9, 2024, incorporated herein by reference in its entirety.

### BACKGROUND

### 1. Technical Field

The present disclosure relates to a coating apparatus for applying a coating material to an object to be coated.

### 2. Description of Related Art

Japanese Unexamined Patent Application Publication No. 2023-133699 (JP 2023-133699 A) discloses a coating apparatus that is capable of suitably discharging a coating material, while suppressing inclusion of air bubbles in the coating material discharged from a die head.

### SUMMARY

However, air bubbles cannot be sufficiently removed in the related art, and accordingly, coating material containing a substantial amount of air bubbles may be discharged from the die head. When coating is performed in a state in which the coating material contains a great amount of air bubbles, coating unevenness occurs, and accordingly, there are cases in which trial coating is performed when starting coating, as a measure against air bubbles. However, performing such trial coating is problematic in that additional coating material is consumed. Thus, technology that enables suitable coating to be performed without performing trial coating is desired.
(1) According to an aspect of the present disclosure, there is provided a coating apparatus for applying a coating material to an object to be coated.
   The coating apparatus includes a coating unit that includes a tank accommodating the coating material, a die head for discharging the coating material, a supply passage making up a channel from the tank to the die head, a volume changing device for imparting a volume change to the supply passage, and a pressure sensor for detecting pressure of internal space of the die head, and a control unit that controls operation of the coating unit.
   The control unit is configured to determine whether the coating material is dischargeable from the die head by change in the pressure when the volume change is imparted to the supply passage by the volume changing device, and to start discharge of the coating material to the object to be coated when dischargeable.
   According to this coating apparatus, determination can be made regarding whether discharging can be performed due to influence of air bubbles in the supply passage, from the pressure change when the volume change is applied in the supply passage of the coating material, and discharging of the coating material to the object to be coated can be executed when determination is made that discharging can be performed. Thus, suitable coating can be performed without performing trial coating.
(2) In the above coating apparatus,
   the control unit may be configured to execute air bubble removal processing for removing air bubbles that are present in the internal space of the die head, when not dischargeable.
   According to this coating apparatus, recovery to a state in which discharging can be performed is enabled by removing air bubbles that are present in the internal space of the die head.
(3) In the above coating apparatus,
   the coating unit may further include a head circulation passage making up a channel from the die head to the tank, and
   the control unit may be configured to execute, as the air bubble removal processing, first processing of returning the coating material that is accommodated in the internal space of the die head to the tank via the head circulation passage.
   According to this coating apparatus, air bubbles that are present in the internal space of the die head can be removed by returning the coating material accommodated in the internal space of the die head to the tank.
(4) In the above coating apparatus,
   the control unit may be configured to execute, as the air bubble removal processing, second processing of externally discharging the coating material accommodated in the internal space of the die head, from the die head.
   According to this coating apparatus, air bubbles that are present in the internal space of the die head can be removed by externally discharging the coating material accommodated in the internal space of the die head.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic view showing a configuration of a coating apparatus;

FIG. 2 is a flowchart of a coating process according to the embodiment;

FIG. 3 is a graph showing pressure-change inside the die head in low bubbles; and

FIG. 4 is a graph showing pressure changes inside the die head in a state where there are many bubbles.

### DETAILED DESCRIPTION OF EMBODIMENTS

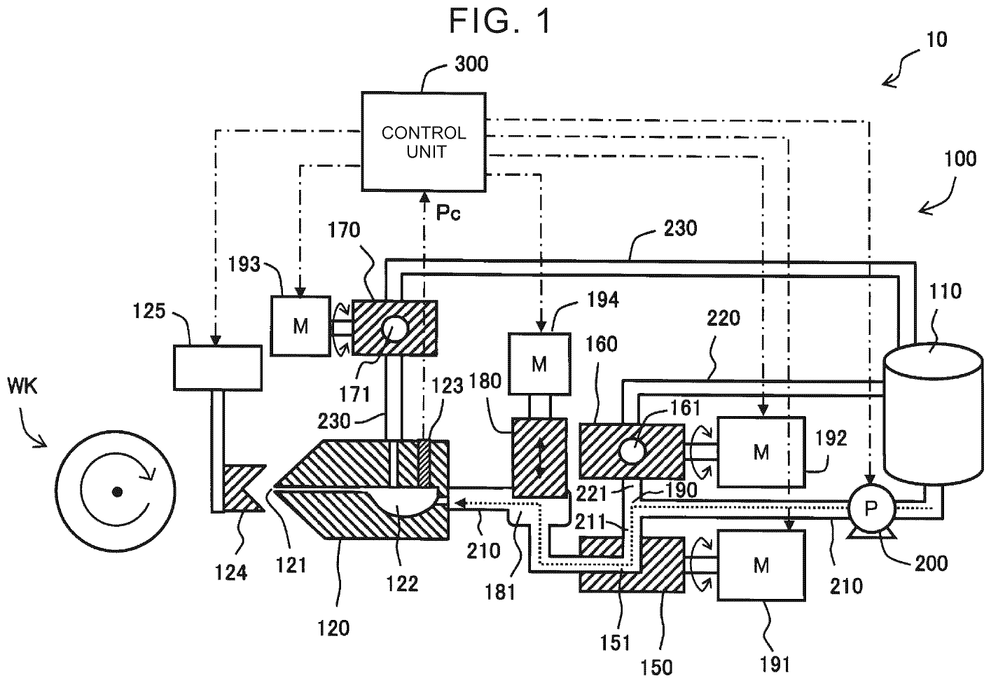

FIG. 1 is a schematic diagram illustrating a configuration of a coating unit 100 according to an embodiment. The coating unit 100 includes a coating unit 100 that performs coating of the coating material with respect to the object to be coated WK, and a control unit 300 that controls the coating unit 100.

The coating unit 100 includes a tank 110, a die head 120, a first pipe 210, and a second pipe 220. The tank 110 is configured to store a liquid or pasty coating material. The die head 120 is configured to eject coating material. The first pipe 210 constitutes a channel from the tank 110 to the die head 120. The second pipe 220 branches off from the first pipe 210 and is connected to the tank 110. A branch portion 190 is provided between the first pipe 210 and the second pipe 220. The coating unit 100 further includes a coating valve 150 disposed between the branch portion 190 and the die head 120, and a first circulation valve 160 disposed in the second pipe 220. A pump 200 is disposed in a portion of the first pipe 210 between the branch portion 190 and the tank 110. A suck-back valve 180 as a volume changing device is disposed in a portion of the first pipe 210 between the die head 120 and the coating valve 150.

The die head 120 and the tank 110 are further connected from the die head 120 by a third pipe 230 constituting a channel of the tank 110. A second circulation valve 170 is disposed in the third pipe 230. The third pipe 230 is preferably connected to the upper surface of the die head 120 so as to extend vertically upward from the die head 120.

In FIG. 1, the operation directions of the coating valve 150, the first circulation valve 160, the second circulation valve 170, and the suck-back valve 180 are indicated by arrows. The first pipe 210 corresponds to a “supply passage” in the present disclosure. The third pipe 230 corresponds to a “head circulation passage” in the present disclosure.

The tank 110 stores a coating material in a fluid form or a paste form. The coating material is, for example, a catalyst ink of a fuel cell. The pump 200 is used to supply the coating material from the tank 110 to the first pipe 210. The pump 200 is also used to return the coating material from the first pipe 210 to the tank 110 via the second pipe 220 or the third pipe 230.

The coating valve 150 has a substantially cylindrical shape, and is provided with a hole 151 that passes from an outer peripheral surface of the substantially cylindrical shape to an end surface thereof through the central axis. The hole 151 is connected to the first pipe 210. The coating valve 150 is driven to rotate by a first motor 191 connected to the coating valve 150 with the center axis of the substantially cylindrical cylinder as the center axis of rotation. When the coating valve 150 is rotated so that the position of the opening on the upstream side of the hole 151 and the position of the first pipe 210 coincide with each other, a valve open state is established in which the coating material can pass through the hole 151. As a result, the coating material flows toward the die head 120, and the coating material is discharged from the die head 120. On the other hand, when the coating valve 150 is rotated so that the position of the opening on the upstream side of the hole 151 and the position of the first pipe 210 do not coincide with each other, the coating valve 150 is in a closed state in which the coating material cannot pass therethrough. In FIG. 1, the coating valve 150 is in an open state.

The first circulation valve 160 is disposed vertically above the coating valve 150. The first circulation valve 160 has a substantially cylindrical shape similar to the coating valve 150, and has a hole 161 that passes from the outer peripheral surface of the substantially cylindrical body to the center axis of the substantially cylindrical body and passes through to the outer peripheral surface on a diagonal line. The first circulation valve 160 is driven to rotate by a second motor 192 connected to the first circulation valve 160 with the center axis of the substantially cylindrical cylinder as a rotation axis center. When the first circulation valve 160 is rotated so that the position of the opening of the hole 161 and the position of the second pipe 220 coincide with each other, the first circulation valve 160 is in an open state in which the coating material can pass through the hole 161. This allows the coating material to flow through the second pipe 220. On the other hand, when the first circulation valve 160 is rotated so that the position of the opening of the hole 161 and the position of the second pipe 220 do not coincide with each other, the first circulation valve 160 is in a valve-closed state in which the coating material cannot pass through. In FIG. 1, the first circulation valve 160 is in a closed state.

The second circulation valve 170 is disposed in a third pipe 230 serving as a head circulation passage. The second circulation valve 170 has the same configuration as the first circulation valve 160 and has a hole 171. The second circulation valve 170 is driven to rotate by a third motor 193 connected to the second circulation valve 170. In FIG. 1, the second circulation valve 170 is in a closed state.

The portion 211 of the first pipe 210 from the branch portion 190 to the coating valve 150 extends downward from the branch portion 190 along the vertical direction. A portion 221 of the second pipe 220 from the branch portion 190 to the first circulation valve 160 extends upward from the branch portion 190 along the vertical direction. The portion 221 of the second pipe 220 functions as an air reservoir for storing the air contained in the coating material from the branch portion 190 toward the coating valve 150.

The suck-back valve 180 is a substantially cylindrical piston disposed between the die head 120 and the coating valve 150, and is configured to be insertable into the valve chamber 181 provided in the first pipe 210. The valve chamber 181 is also referred to as a “suck-back chamber”. A fourth motor 194 is connected to the suck-back valve 180. The suck-back valve 180 moves forward to the inside of the valve chamber 181 or backward from the valve chamber 181 by power received from the fourth motor 194. As the suck-back valve 180 advances, the volume of the supply passage of coating material decreases and the pressure in the supply passage increases. On the other hand, when the suck-back valve 180 is retracted, the volume of the supply passage of the coating material increases, and the pressure in the supply passage decreases. The suck-back valve 180 corresponds to a volume changing device that imparts a volume change to the supply passage of the coating material. However, a volume changing device other than the suck-back valve 180 may be used.

The die head 120 is a member in which a slit 121 for discharging is formed at a distal end portion thereof, and is connected to the first pipe 210 and the third pipe 230. The front end portion of the die head 120 is disposed so as to face the roll-shaped object to be coated WK. The die head 120 discharges the coating material that has flowed in through the first pipe 210 from the slit 121, and forms a coating film of the coating material on the surface of the object to be coated WK that rotates at a position facing the front end of the die head 120.

A storage chamber 122 for storing coating material is provided inside the die head 120. The storage chamber 122 is a kind of internal space of the die head 120. The storage chamber 122 is provided with a pressure sensor 123 that measures the pressure in the internal space of the die head 120.

The coating unit 100 further includes a cap 124 that is attachable to and detachable from the distal end portion of the die head 120, and a cap driving mechanism 125 that performs an attaching and detaching operation of the cap 124. When the cap 124 is attached to the distal end portion of the die head 120, the slit 121 of the die head 120 can be closed. For example, when the suck-back valve 180 is used to impart a change in volume to the supply passage of the coating material, the cap 124 is attached to the die head 120, so that the change in pressure in the supply passage due to the change in volume can be measured more accurately. Such sealing of the die head 120 is particularly beneficial when the thickness of the slit 121 is less than or equal to 0.05 mm. Note that the cap 124 and the cap driving mechanism 125 may be omitted.

In the coating apparatus 10 of the present embodiment, the ejection state and the two circulation states described below can be used. The discharge state is a state in which the coating material stored in the tank 110 reaches the die head 120 via the first pipe 210 and is discharged to the outside from the die head 120 in accordance with the operation of the suck-back valve 180. In the discharge state, the coating valve 150 is set to the open state, and the first circulation valve 160 and the second circulation valve 170 are set to the closed state. The dotted arrows shown in FIG. 1 indicate the flow of the coating material in the discharge state. The suck-back valve 180 is advanced into the valve chamber 181 while the coating material is stored in the storage chamber 122 of the die head 120. The pressure Pc in the inner space of the die head 120 increases, and the coating material is discharged to the outside from the slit 121 of the die head 120.

### First Circulation State

The first circulation state is a state in which the coating material in the first pipe 210 returns from the branch portion 190 to the tank 110 via the second pipe 220. In the first circulation state, the coating valve 150 and the second circulation valve 170 are set to the closed state, and the first circulation valve 160 is set to the open state.

### Second Circulation State

The second circulation state is a state in which the coating material in the die head 120 returns to the tank 110 via the third pipe 230. In the second circulation state, the coating valve 150 and the second circulation valve 170 are set to the open state, and the first circulation valve 160 is set to the closed state. This second circulation state can be used in a bubble removal process described later.

In both the discharge state and the two circulation states described above, the coating material is driven by the pump 200 and flows in the first pipe 210 in the direction toward the branch portion 190. Therefore, the inside of the first pipe 210 is maintained in a state of being filled with the coating material.

The control unit 300 acquires the pressure Pc of the inner space of the die head 120 measured by the pressure sensor 123, and controls the operation of the motor 194 from the pump 200 and the motor 191. As will be described later, the control unit 300 determines whether or not to execute coating in accordance with a change in pressure in the internal space of the die head 120 that occurs in association with the operation of the suck-back valve 180. The control unit 300 may be configured as a computer having a processor and a memory, or may be configured as a hardware circuit. In the former case, a computer program that implements the function of the control unit 300 is stored in a memory.

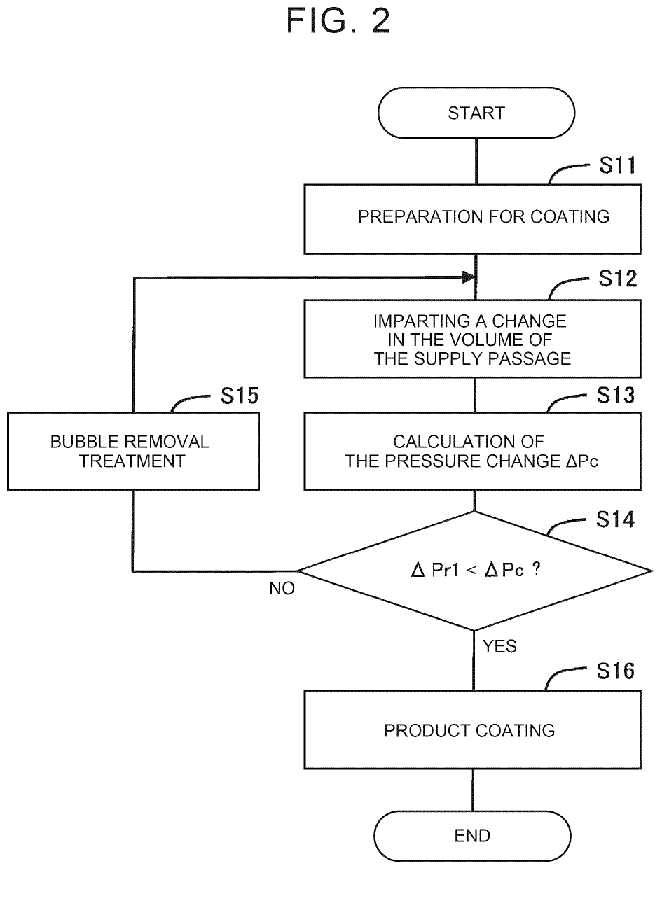

FIG. 2 is a flowchart of a coating process according to the embodiment. The processing of FIG. 2 may be performed periodically when the product coating is performed, or may be performed at an arbitrary timing according to an instruction from an operator.

In S11, the control unit 300 prepares for coating. In preparation for coating, for example, by operating the pump 200 in the above-described circulation state, an operation of supplying the coating material from the tank 110 to the die head 120 via the first pipe 210 is performed. Further, it is preferable to fill the second pipe 220 and the third pipe 230 with the coating material by operating the pump 200 in each of the first circulation state and the second circulation state described above.

In S12, the control unit 300 applies a volume change to the supply passage of the coating material. In the present embodiment, the change in the volume of the supply passage is performed by advancing and retracting the suck-back valve 180. The application of the volume change is preferably carried out in the above-described second circulation state. A cap 124 is preferably attached to a distal end portion of the die head 120.

In S13, the control unit 300 calculates the pressure change ΔPc of the inner space of the die head 120 according to the volume change of the supply passage. The pressure change ΔPc is a difference between the largest value and the smallest value of the pressure Pc in the inner space of the die head 120.

In S14, the control unit 300 compares the pressure change ΔPc in the inner space of the die head 120 with a preset reference value ΔPr1.

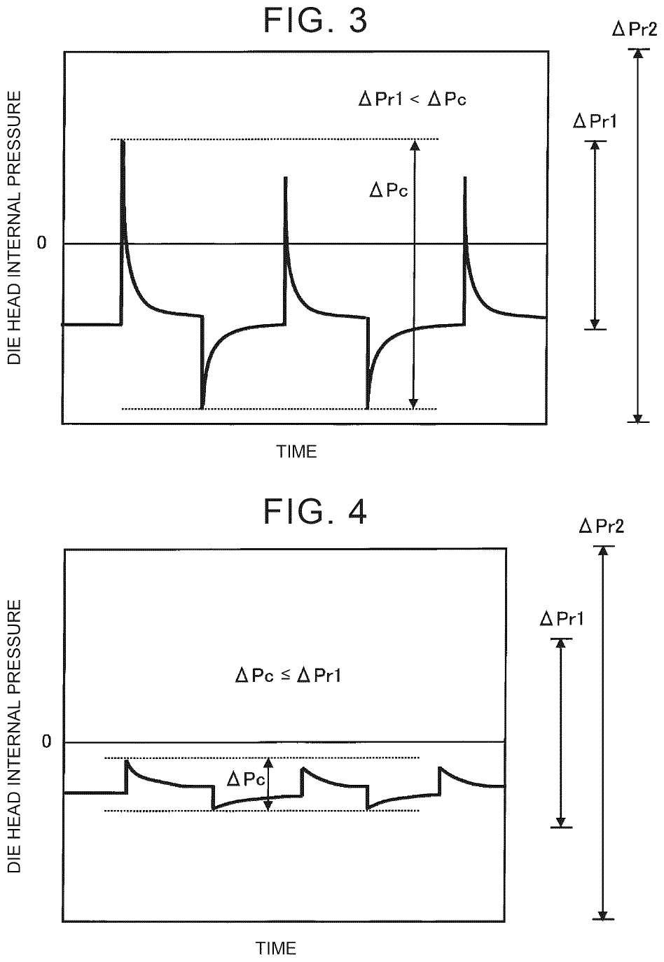

FIG. 3 is a graph showing a pressure change ΔPc in the die head 120 in a state where there are few bubbles in the internal space of the die head 120. FIG. 4 is a graph showing a pressure change ΔPc in the die head 120 in a state where there are many bubbles in the internal space of the die head 120. In these examples, the suck-back valve 180 is advanced and retracted three times. The forward movement amount and the backward movement amount of the suck-back valve 180 in FIGS. 3 and 4 are each a predetermined constant value.

In the example of FIG. 3, since the number of bubbles contained in the internal space of the die head 120 is small, the pressure change ΔPc in the internal space of the die head 120 is large. On the other hand, in the example of FIG. 4, since many bubbles are contained in the internal space of the die head 120, the volume change of the supply passage is absorbed by the volume change of the bubbles, and the pressure change ΔPc in the internal space of the die head 120 is small. As described above, the pressure change ΔPc in the internal space of the die head 120 tends to increase as the number of bubbles included in the supply passage of the coating material decreases, and tends to decrease as the number of bubbles increases.

In S14, when the pressure change ΔPc is equal to or less than the reference value ΔPr1, it is considered that the coating is affected by bubbles, and the process proceeds to S15, and the control unit 300 executes the bubble removing process. As the bubble removal processing, for example, the following first processing and second processing can be used.

### First Treatment of Bubble Removal

The first process is a process in which the coating unit 100 is set to the above-described second circulation state, and the coating material in the internal space of the die head 120 is returned to the tank 110 via the third pipe 230. When the first process is executed, the bubbles contained in the coating material in the internal space of the die head 120 can be removed. In order to efficiently remove the bubbles by the first process, the third pipe 230 is preferably connected to the upper surface of the die head 120, and in particular, is preferably provided so as to extend vertically upward from the upper surface of the die head 120.

### Second Treatment of Bubble Removal

The second process is a process of discharging the coating material existing in the internal space of the die head 120 from the slit 121 to the outside. In this second process, the coating unit 100 is set to the above-described ejection state. Since the coating material ejected in the second treatment is not applied to object to be coated WK, the second treatment is also referred to as “blanking treatment”. In this second process, the bubbles contained in the coating material in the internal space of the die head 120 can be discharged to the outside.

From the viewpoint of reducing wasteful consumption of the coating material, the first treatment is preferable to the second treatment. On the other hand, from the viewpoint of shortening the processing time, the first processing may be preferable. As the bubble removal processing, only one of the first processing and the second processing may be executed, or both of the first processing and the second processing may be executed. Further, other types of bubble removal processing may be performed. After S15 is executed, the process returns to S12, and the processes after S12 are executed again.

In S14, when the pressure change ΔPc is larger than the reference value ΔPr1, it is considered that there is no effect of bubbles on the coating, and the process proceeds to S16, and the control unit 300 executes the coating of the product. That is, the coating material is ejected from the die head 120 to object to be coated WK to form a coating film of the coating material on the surface of the object to be coated WK.

As shown in FIGS. 3 and 4, as the reference value of the pressure change ΔPc, in addition to the first reference value ΔPr1, a second reference value ΔPr2 larger than the first reference value ΔPr1 may be used. In this case, when the pressure change ΔPc is equal to or greater than the second reference value ΔPr2, the continuous execution length of the product coating may be increased as compared with the case where the pressure change ΔPc is greater than the first reference value ΔPr1 and less than the second reference value ΔPr2. The “continuous execution length of product coating” is the sum of the relative distances at which the slit 121 relatively moves on the surface of the object to be coated WK while discharging the coating material when the product coating is continuously or intermittently performed without performing the process of confirming the bubbles by S14 from S12.

The application of the volume change of the supply passage in S12 is preferably performed a plurality of times as illustrated in FIGS. 3 and 4. In addition, it is preferable to reduce the volume of the supply passage so that the coating material is not ejected from the die head 120. For example, if the volume of the supply passage is changed in a state where the cap 124 is attached to the distal end portion of the die head 120, it is possible to prevent the coating material from being ejected from the die head 120. Alternatively, the volume change of the supply passage may be performed in a state where the cap 124 is not attached to the distal end portion of the die head 120. In this case, the amount of advancement of the suck-back valve 180 in S12 may be set to be smaller than that in the execution of the coating in S16, thereby preventing the coating material from being ejected from the die head 120.

According to the processing procedure of FIG. 2, good coating can be performed without performing trial coating. For example, when a test coating is performed to confirm the coating state, there is a problem that the coating material is wastefully consumed for test coating, resulting in an increase in manufacturing cost. On the other hand, in the present embodiment, there is an advantage that good coating can be performed without performing trial coating.

As described above, in the present embodiment, it is possible to confirm whether or not there is an influence of air bubbles on the coating from the pressure change when the volume change is applied in the supply passage of the coating material. In addition, it is possible to determine whether or not the coating material can be ejected in accordance with the change in pressure. When it is determined that the coating material can be ejected, the coating material can be ejected onto object to be coated WK. Therefore, it is possible to perform good coating without performing trial coating.

### Other Forms

The present disclosure is not limited to the above-described embodiments, and can be realized in various forms without departing from the spirit thereof. For example, the present disclosure can also be realized by the following aspect. The technical features in the above-described embodiments corresponding to the technical features in the respective embodiments described below can be appropriately replaced or combined in order to solve some or all of the problems of the present disclosure. The technical features in the above-described embodiments corresponding to the technical features in the respective embodiments described below can be appropriately replaced or combined in order to achieve some or all of the effects of the present disclosure. When the technical features are not described as essential in this specification, the technical features can be deleted as appropriate.

The present disclosure can be realized in various forms other than the coating apparatus. The present disclosure can be realized, for example, in the form of a computer program, a non-transitory recording medium (non-transitory storage medium) in which the computer program is recorded, or the like. The computer program executes a coating method, a control method of the coating apparatus, and processing by the coating apparatus.

What is claimed is:

1. A coating apparatus for applying a coating material to an object to be coated, the coating apparatus comprising:
a coating unit that includes a tank accommodating the coating material, a die head for discharging the coating material, a supply passage making up a channel from the tank to the die head, a volume changing device for imparting a volume change to the supply passage, and a pressure sensor for detecting pressure of internal space of the die head; and
a control unit that controls operation of the coating unit, wherein the control unit is configured to determine whether the coating material is dischargeable from the die head by change in the pressure when the volume change is imparted to the supply passage by the volume changing device, and to start discharge of the coating material to the object to be coated when dischargeable.

2. The coating apparatus according to claim 1, wherein the control unit is configured to execute air bubble removal processing for removing air bubbles that are present in the internal space of the die head, when not dischargeable.

3. The coating apparatus according to claim 2, wherein
the coating unit further includes a head circulation passage making up a channel from the die head to the tank, and
the control unit is configured to execute, as the air bubble removal processing, first processing of returning the coating material that is accommodated in the internal space of the die head to the tank via the head circulation passage.

4. The coating apparatus according to claim 2, wherein the control unit is configured to execute, as the air bubble removal processing, second processing of externally discharging the coating material accommodated in the internal space of the die head, from the die head.
